(19) United States
(12) Patent Application Publication
(10) Pub. No.: US 2026/0320654 A1
(43) Pub. Date: Oct. 15, 2026

(54) Method And System For Bidding On Uncontested Search Auctions For AI Chatbots

(71) Applicant: Taskmaster Technologies Inc., San Juan Bautista, CA (US)

(72) Inventor: Matt LeBaron, Salinas, CA (US)

(21) Appl. No.: 19/330,721

(22) Filed: Sep. 16, 2025

Related U.S. Application Data
(63) Continuation-in-part of application No. 19/198,706, filed on May 5, 2025.
(60) Provisional application No. 63/642,872, filed on May 5, 2024.

(51) Int. Cl. G06Q 30/0273

(52) U.S. Cl. CPC G06Q 30/0275

(57) ABSTRACT

Adjusting internet advertising bids in internet advertising campaigns, including maintaining at least one auction rule that that specifies how to adjust a bid for a search term in an internet advertising auction in the case that the auction is determined to be uncontested, where a successful bid for a search term results in a corresponding paid ad provided by an advertiser to appear in a chatbot response, and, where in an uncontested auction the chatbot response displays only one paid ad, the paid ad provided by the advertiser, computing a contest score that estimates the likelihood that an auction for the search term is uncontested, determining, based on the contest score that the auction is uncontested; and performing an uncontested auction method that executes a bid for the search term.

### TECHNICAL FIELD

The present invention relates to search advertising technology, specifically to the ability to identify and bid on uncontested auctions for ads where the ads are incorporated into chatbot responses.

### BACKGROUND

The subject application and claims are directed most generally to two technical fields. The first is referred to variously as search advertising, search advertising technology, digital advertising technology, digital advertising, advertising technology or adtech. The specific area addressed in this patent relates to the GOOGLE AD WORD system, and to similar search advertising systems, which was first introduced in August 2000. A substantial amount of technology has been developed around the GOOGLE AD WORDS platform in that time, including U.S. Pat. No. 11,727,434 by Matt LeBaron et al. which is hereby incorporated in its entirety by reference.

The second technical field is referred to as large language models (LLMs) or AI chatbots, or simply chatbots, which are a type of artificial intelligence (AI) designed to understand, process, and generate human language.

In traditional Web search, an Internet search engine returns one or more web pages to a user's browser in response to a keyword search performed by the user. The returned web pages, known as “search engine results pages” or SERPs, include unpaid search listings, commonly referred to as “organic” search results, as well as paid advertisements, also referred to as paid ads or ads. Each unpaid listing or ad includes a URL, or link to a worldwide web page, which is relevant to a search term entered by the user. The web page that corresponds to a URL returned in an ad or unpaid listing in a SERP is often referred to as a landing page.

The goal of search advertising is to induce users to click on paid ads and then perform a desired action, which typically entails visiting an advertiser's website or making an immediate purchase. The effectiveness of an online advertising campaign for an advertiser may be measured in several ways, for example by the number of clicks on paid ads ran by the advertiser, where a click results in a visit to the advertiser site, and by the amount of revenue generated by those visits.

However, each time a visitor clicks on a paid ad the advertiser pays a bid price to the organization that operates the search engine which generated the corresponding SERP. The effectiveness of the advertising campaign can be further measured by the ratio of revenue generated to the advertising expenditure, or by the ratio of visitors to advertising expenditure. Thus, a key goal is to minimize the advertising cost while achieving the desired visits and corresponding revenue.

Generally, an advertiser or bidder bids on a keyword as part of an auction process. If there are multiple bids then the rank or position of each ad in a SERP is determined by the bid price for the ad, where higher bid prices secure higher or better positions in the SERP. If there is only one bidder in an auction, referred to herein as an uncontested auction, then that bidder's paid ad is the only paid ad that appears.

The reserve price is set by the search engine and is typically not communicated to bidders. This enables the search engine to set the reserve price at a level that achieves their own goals, which may be to maximize revenue or achieve a number or percentage of clicks. However, it is always in the interest of the bidder to pay the least price for a bid that secures a desired position for their ad in the SERP.

The search engine typically sets the reserve price based on bid values that it sees over time. Since uncontested auctions account for a significant percentage of auctions, in some cases it is possible for bidders to affect the reserve price by their bidding strategy. For example, if bidders in uncontested auctions consistently bid below the reserve price this may cause the search engine to lower the reserve price.

However, in the case of chatbot interactions there is not yet a standard approach for integrating and displaying paid advertisements into chatbot responses. For example, FIG. 6A illustrates a response 602 of a chatbot to a simple query regarding local supermarkets. A list of ads 604 is provided by the chatbot in response to the query. It is unclear whether the list of supermarkets 604 includes paid ads. It is expected that, in the future, chatbot responses will increasingly incorporate paid ads Thus, it is feasible and perhaps likely that the approach to bidding on and purchasing paid ads described hereinabove will be integrated within chatbot systems.

Thus, it would be advantageous for bidders whose paid ads appear in chatbot interactions to be able to identify uncontested auctions and to determine methods that reduce the search engine reserve price in order to reduce the overall cost of their ad campaigns.

### SUMMARY

The invention is a method, system, and device that determines if search engine auctions for a keyword and its corresponding paid ad are contested or uncontested and adjusts the bids for uncontested auctions to significantly reduce the cost of a paid advertising campaign.

The invention works with both search engine results pages (SERPs) returned by search engines and with chatbot results provided by AI chatbot systems.

In one embodiment, the subject invention adjusts internet advertising bids in internet advertising campaigns and executes the adjusted bids, where the steps in the method include maintaining at least one auction rule that that specifies how to adjust a bid for a search term in an internet advertising auction in the case that the auction is determined to be uncontested, where a successful bid for a search term results in a corresponding paid ad provided by an advertiser appearing in a chatbot response, and, where in an uncontested auction the SERP displays only one paid ad, the paid ad provided by the advertiser, computing a contest score that estimates the likelihood that an auction for the search term is uncontested, determining, based on the contest score that the auction is uncontested; and performing an uncontested auction method that executes a bid for the search term.

In certain embodiments the uncontested auction method performs a bid walkdown method that lowers the reserve price for the search term and then executes a bid for the search term at the lowered reserve price.

### BRIEF DESCRIPTION OF THE DRAWINGS

The subject invention will be more fully understood and appreciated from the following detailed description, taken in conjunction with the drawings in which:

FIG. 1 is a simplified block diagram of a search advertising system (SAS) that analyzes search engine results pages (SERPS) to determine if an auction for a keyword is contested or uncontested and sets bid prices based on the results.

FIG. 2 is an example of a search engine results page (SERP) 200 that shows a SERP for an uncontested auction.

FIG. 3A provides a first embodiment of an overall method that identifies contested and uncontested auctions for a search term and adjusts and executes bids accordingly.

FIG. 3B provides a first embodiment of a method that computes a Contest Score for an auction for a search term that estimates the likelihood that the auction was uncontested over a sample period.

FIG. 4A provides a flow diagram of an overall method for adjusting bids for a search term in cases where an auction for the search term is uncontested.

FIG. 4B provides a flow diagram of a bid walkdown method that retrains a search engine's bidding algorithm to lower the reserve price for a search term.

FIG. 5 is a block diagram that depicts one embodiment of the software modules of the search advertising system (SAS).

FIG. 6A presents an example of a chatbot response received in response to a chatbot query posed by a user.

FIG. 6B presents a second example of a chatbot response received in response to a chatbot query posed by a user.

FIG. 7 is a simplified block diagram of a chatbot advertising system (CAS) that analyzes chatbot responses to determine if an auction for a keyword is contested or uncontested and sets bid prices based on the results.

FIG. 8A provides a second embodiment of an overall method that identifies contested and uncontested auctions for a search term and adjusts and executes bids accordingly.

FIG. 8B provides a second embodiment of a method that computes a Contest Score for an auction for a search term that estimates the likelihood that the auction was uncontested over a sample period.

The figures depict embodiments of the present invention for purposes of illustration only. One skilled in the art will readily recognize from the following discussion that alternative embodiments of the structures and methods illustrated herein, as well as combinations of embodiments, may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

User—as used herein refers an individual that uses a mobile device, personal computer or other electronic device to perform web searches, chatbot interactions, to click on ads, and to visit the websites and web pages that correspond to the ads.

Advertiser or advertiser—refers to an individual, company or other organization that places an online ad, or causes an online advertisement, or paid ad, to be placed, via a search engine for a good or service that they are advertising, selling, or promoting. In certain cases, an advertiser makes bidding decisions, i.e. determines whether or not to bid on a paid ad, and what price to bid. In certain cases, an advertiser works with a web advertising agency or another individual or company to place bids; in such cases the advertiser together with any agency or individual is collectively referred to as the advertiser.

Keyword or search term—refers to a word, words, phrase or sentence entered by a user into a search field in a web page, also referred to as a keyword query, which is then transmitted to a search engine that performs the requested search and returns results. An advertiser may purchase, or bid on, an ad that corresponds to a search term; in that case, the SERP returned by the search engine in response to the user entering the search term includes a paid ad, placed by the advertiser, which corresponds to the search term.

Search engine or Web search engine—means a computer server, or Internet service that receives a search term, typically as a result of a keyword query, uses the search terms to search for web pages that correspond to the search terms and returns one or more search engine results pages (SERPs) that include paid ads, and unpaid, or organic, listings.

Keyword bid—means to provide to a search engine a maximum amount of money an advertiser will pay when a user clicks on a paid advertisement or ad supplied by the advertiser to the search engine, where the paid ad corresponds to a keyword or search term that a user enters. Adjusting a bid means to change the price relative to a previous bid or decide to bid or not bid on a search term. It may be appreciated that a bid may include additional information such as a reserve price that the advertiser will pay if there is no other bidder and an advertising budget not to exceed for the search term or for a group of search terms.

Listing—is a result from a search term search that appears in a SERP. Each listing includes a link to a corresponding web page. A listing can be a paid ad, i.e. a paid listing, or an unpaid, or organic, listing, which is generated by a search engine. Listings in a SERP are ranked; each listing has a numerical position starting from the top, or first, or highest, position. Unless otherwise specified, a listing position in a SERP refers to the numerical position of a listing from the top in the unpaid search results. Thus, first position is the highest position, second is the next highest position, etc. Paid listings, which correspond to paid ads, have a paid listing position and unpaid listings have an unpaid listing position.

Search Engine Results Page (SERP)—means a sequence of one or more web pages returned by a search engine in response to a keyword search. Each element in the list, i.e. each listing, typically includes a title, a URL or link to the web page, and a short description showing where the search terms have matched content within the page. A SERP may refer to a single web page that includes a sequence of paid and unpaid listings, or to the set of all links returned for a search query possibly spanning multiple web pages.

Auction—refers to an auction to place a paid ad that displays in a SERP generated by a search engine when a user enters a search term that corresponds to the search term that corresponds to the paid ad. Paid ads that correspond to higher bids receive better placement in the SERP. It may be appreciated that the subject invention applies to other types of online advertising other than search engine advertising that generates SERPS. For example, in some cases, when a search engine returns a map or a direct offer in response to a search request. While the method and definitions herein correspond to the GOOGLE ADWORDS system they can be applied to other search engines as well.

Uncontested auction—means that there is a single bidder in an auction for a search term or no bidder at all. It is assumed that when there is a single bid for a search term, the corresponding paid ad appears in the best position for paid ads in the SERP, provided that the bid is at least as high as a reserve price, where the reserve price, as used in herein, refers to the minimum bid that a search engine will accept to run an ad.

Contested auction—means that there are at least two bids in an auction for a search term and at least two paid ads display in a SERP.

Landing page—means a web page whose URL corresponds to a listing in a SERP. When a user clicks on a listing in a SERP the web browser requests and displays the corresponding landing page. In certain cases, a listing in a SERP may not have a corresponding landing page. For example, clicking on a paid ad may make a phone call, this is referred to as “click-to-call.” Typically, a landing page is within the domain of the advertiser or advertiser.

Chatbot or AI Chatbot or LLM—as used herein refers to a type of artificial intelligence (AI) designed to understand, process, and generate human language. The term chatbot, as used herein, is an interactive service that interacts with users to perform various tasks such as answering questions, summarizing text, translating languages, writing different kinds of creative content, and having conversational interactions. The current generation of chatbots use a type of machine learning referred to as large language models (LLMs). However, the subject invention does not depend on or require any particular interactive language technology. For this reason, the term chatbot is used herein, although in common parlance the terms chatbot, AI chatbot and LLM are used interchangeably.

### Overview of the Application

The invention identifies a fundamental principle of search engine advertising technology which is that search engines handle the cases of contested and uncontested auctions very differently and that a bidding strategy can address the two cases differently. The core of the invention is a method, or sequence of actions, which enables an advertiser to substantially reduce the cost of an online ad campaign by identifying uncontested auctions and applying a method that significantly lowers bid prices in those cases. This uncontested bid method is based on identification of uncontested auctions, which has not been recognized in the prior art as an important factor in search engine advertising technology. The invention does not address techniques for determining bid prices in contested auctions since this subject has been dealt with exhaustively in the prior art.

### Generalized Operation

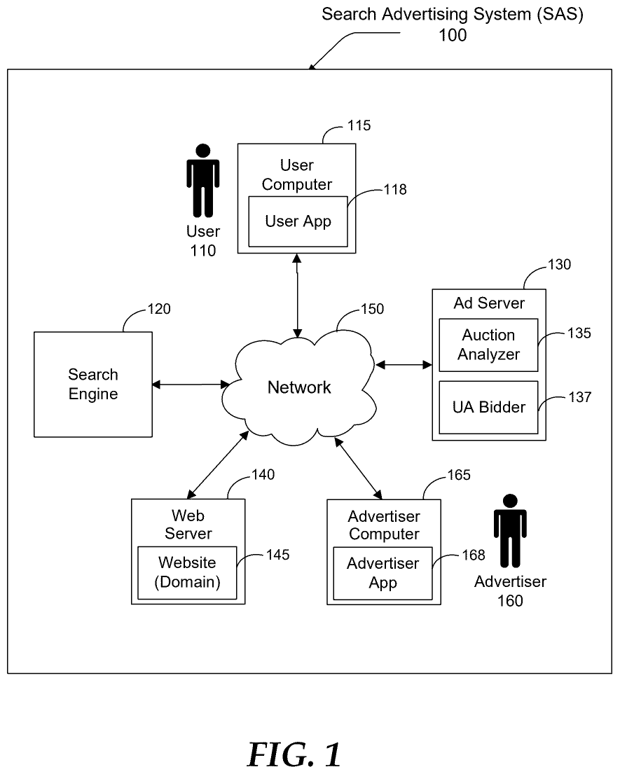

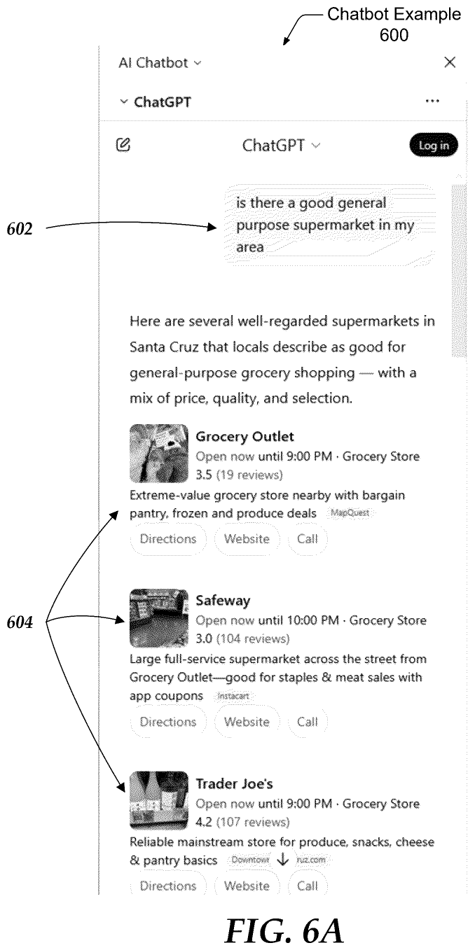

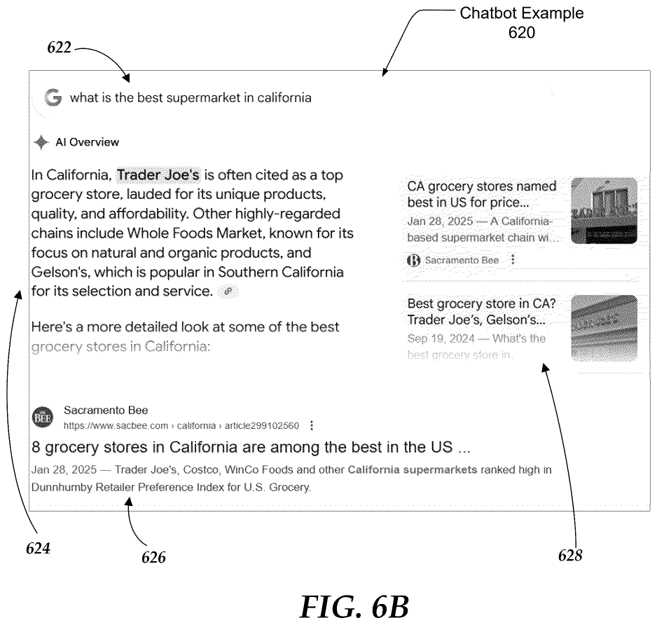

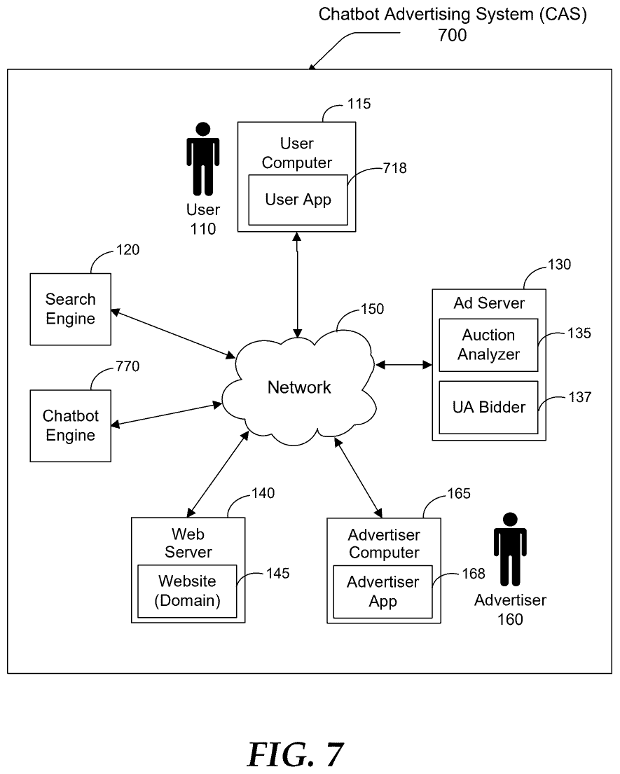

The operation of certain aspects of the invention is described below with respect to FIGS. 1-8. Generally, this invention relates to and shares certain aspects of the basic methods and systems disclosed in U.S. patent application Ser. No. 19/198,706 by the same inventors. The present invention addresses cases in which paid advertisements are incorporated into chatbot responses. The systems, methods and devices disclosed relate specifically to the GOOGLE AD WORDS system but also apply generally to all search engines including MICROSOFT BING and YAHOO! and all chatbots including GOOGLE GEMINI and OPEN AI CHATGPT. Generally, FIGS. 1-5 relate to a first embodiment in which paid ads are incorporated into search engine results pages (SERPs) generated by search engines, while FIGS. 6-8 expand the methods and systems to ads that are incorporated into chatbot responses provided by chatbot engines.

FIG. 1 is a simplified block diagram of a search advertising system (SAS) 100 that analyzes search engine results pages (SERPS), determines whether an auction is contested or uncontested and modifies bids based on this determination.

User computer 115 interacts with a user 110 and enables user 110 to perform web searches using a user app 118 and to visit websites and interact with websites. User app 118 may be a standard, commercially available, web browser such as GOOGLE CHROME, MOZILLA FIREFOX or MICROSOFT EDGE. Alternatively, it may also be a custom user application running in user computer 115. User app 118 transmits a search term entered by user 110 to a search engine 120 that performs the requested search and returns a (SERP) which is then displayed by user app 118. The SERP typically includes one or more paid listings, or ads, and one or more unpaid listings. Typically, each listing includes a link to a web page, also referred to as a landing page, which is determined by search engine 120 to match the search term.

User computer 115 is typically a PC, mobile device or other computer system configured to receive and display graphics, text, multimedia, and the like, across a network.

Advertiser 160 uses an advertiser computer 165 running an advertiser app 168 to interact with services provided by ad server 130. In certain embodiments, advertiser app 168 enables advertiser 160 to adjust bids, and view search engine advertising results.

Advertiser app 168 may be a standard, commercially available, web browser such as GOOGLE CHROME, MOZILLA FIREFOX or MICROSOFT EDGE. Alternatively, it may also be a customer user application running in advertiser computer 165. Advertiser computer 165 is typically a PC, mobile device or other computer system configured to receive and display graphics, text, multimedia, and the like, across a network.

A landing page belongs to a domain or a website 145 that is hosted by a web server or web service, referred to simply as web server 140. Web server 140 may host a plurality of domains. The web page may be static, i.e. existing as computer file in HTML format or another format or it may be dynamically generated. Further, web server 140 may provide e-commerce, enabling user 110 to purchase items, or otherwise perform transactions that generate revenue from website 145.

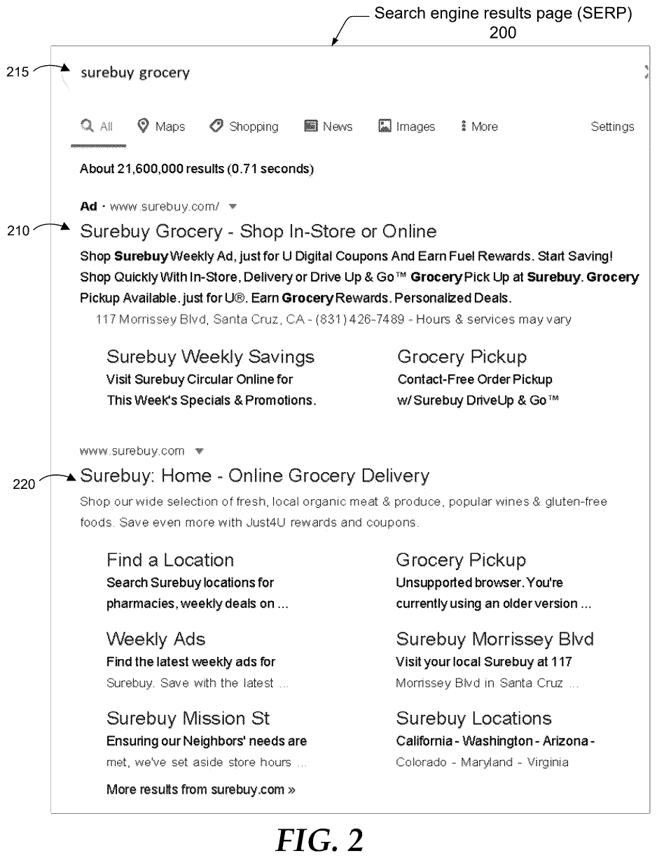

An ad server 130 provides ads to search engine 120 to be included in SERPS. An auction analyzer 135 analyzes a SERP and determines whether any paid ads provided by advertiser 160 which are bid on by ad server 130 result in contested or uncontested auctions. This information is further analyzed to generate a contest score that estimates the likelihood that an auction for a given keyword is contested or uncontested for a period of time, henceforth referred to as a sample interval. More specifically, if a paid ad that corresponds to a search term is being run, i.e. bid upon, auction analyzer 135 determines if the corresponding paid ad that appears in SERPS is the result of a contested or uncontested auction. The operation of auction analyzer 135 and UA bidder is described in greater detail with reference to FIGS. 2-5 hereinbelow.

It may be appreciated that the services performed by auction analyzer 135 and UA bidder 137 may be performed in a different server or computer system than ad server 130. For example, an embodiment described with reference to FIG. 6 discloses the case where auction analyzer 135 and UA bidder 137 operates in a search engine. Further, ad server 130 and/or its component services may be implemented as more than one physical server computer or by a cloud service such as AMAZON AWS.

Network 150 enables the various computers, servers, and services identified in SAS 100 to exchange data. Network 150 typically refers to the public Internet but may also refer to a private network or any combination of private and public networks.

### Example of an Uncontested Auction

FIG. 2 is an example of a search engine results page (SERP) 200 that shows a SERP for an uncontested auction. In response to user 110 entering the search term 215 “surebuy grocery” into browser 118 search engine 120 returns SERP 200. SERP 200 includes a paid listing 210 which is an ad for a grocery store, or chain of grocery stores, named “Surebuy Grocery”. SERP 200 also includes an unpaid listing 220, i.e. an organic search result.

Listing 210 is the first and only paid ad included in SERP 200. It occupies the first listing position for paid ads in the SERP. If a second bid was made and the bid price was equal to or above the reserve price, then it too would have been displayed. This would have been a contested auction. Alternatively, if there is no second bid or a second bid was made, and the second bid price was below the reserve price that ad wouldn't appear in a SERP. In either case, in the example of SERP 200, the auction is considered to be uncontested as just a single paid ad 210 appears.

Listing 220 is an unpaid ad 220. Unpaid ad 220 is in the first unpaid listing position in SERP 200.

Generally, ad server 130 and specifically auction analyzer 135 and UA bidder 137 can be adapted to cases where a SERP doesn't follow the topology previously illustrated in SERP 200 where paid ads are listed in linear order followed by unpaid listings. For example, physical distance on a screen can be measured. Or different regions on a screen can be assigned weights, for example, in a case where paid ads are side-by-side with unpaid listings.

### “Friendly” Ads and “Competitive” Ads

An ad may be categorized as a “friendly” ad or as a “competitive” ad with respect to a specific ad placed by an advertiser. In certain cases, auction analyzer 135 may evaluate a SERP that has two paid ads, one placed by advertiser 160 and determined to be a friendly ad as being uncontested rather than contested.

Example 1: In a first example, if a first company is a business partner with a second company, then it may treat ads by the second company as “friendly” and agree to not advertise competitively with ads placed by the second company. Thus, in this example, a friendly ad in any position among the paid ads implies that the advertiser's own ad is cannibalistic. Several other examples are given below.

Example 2: an auto dealer B sells autos manufactured by auto manufacturer A. Manufacturer A may consider that ads by dealer B for products from manufacturer A are friendly and decide not to advertise when ads by dealer B appear.

Example 3: alternatively, manufacturer A considers that ads placed by dealer B for their products (i.e. products from manufacturer A) are competitive and may want to advertise directly against those ads, i.e. advertise when it is statistically likely that an ad placed by dealer B will appear in a SERP.

Further, an advertiser, by downloading and then analyzing SERPS, a process commonly referred to as “scraping, can easily determine the domain of landing pages for ads in a SERP. Thus, a friendly ad can be considered as an ad with a landing page in a friendly domain and a competitive ad can be considered as an ad with a landing page in a competitive domain. Thus, in certain embodiments, friendly and competitive ads can be determined based on a list of friendly domains and a list of competitive domains. In other embodiments, company and organization names or even product names may be used to determine whether an ad is friendly or competitive.

Thus, from the perspective of an advertiser, each ad in a SERP can be categorized as: 1) their own ad, 2) a friendly ad, 3) a competitive ad, and 4) other, i.e. an ad from a company, organization or domain that is not the advertiser itself, not friendly and not competitive.

More generally, an advertiser may consider an ad placed by a specific company or organization to be friendly or competitive and can implement ad rules to be used to by auction analyzer 135 when analyzing SERPS to determine if an auction is contested or uncontested.

### Contest Score

Auction analyzer 135 analyzes SERPS and generates a contest score that estimates the level of confidence that a paid ad resulted from an uncontested auction over the course of a sample period. A contest score may be a percentage, a numerical score, a Boolean value (True, False) that simply indicates that an ad is deemed to be contested or uncontested. A contest score may also be generated by a statistical function, such as an average, by a machine learning system, or by other means. For example, a contest score of 0.95 or 95% may indicate that auction analyzer 135 estimates that 95% of the ads that appeared in a SERP which was received as a result of a search for a designated keyword were the result of uncontested auctions. Alternatively, it may signify that auction analyzer 135 has 95% confidence that all of the auctions during the sampling period were uncontested.

A contest score may be calculated based on one or more contest rules. For example, the aforementioned rules for evaluating whether an ad is friendly may be taken into account. Contest rules may be based on other factors as well.

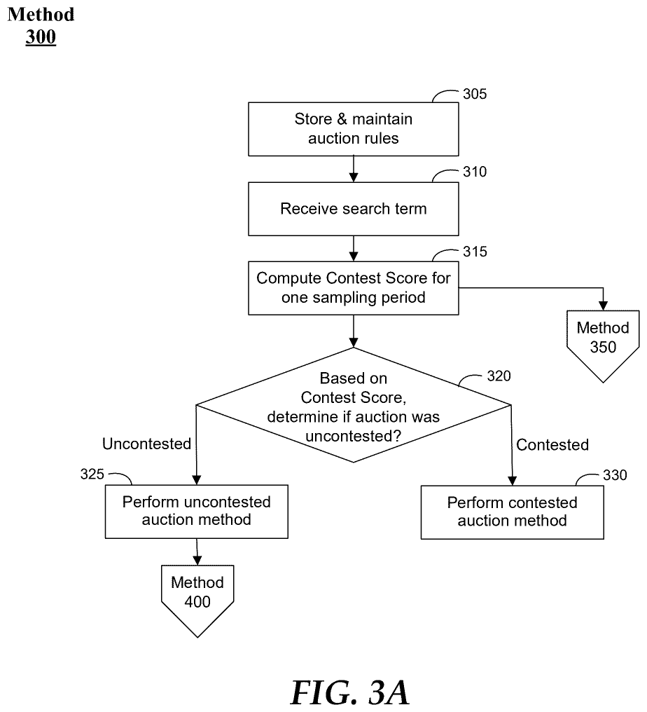

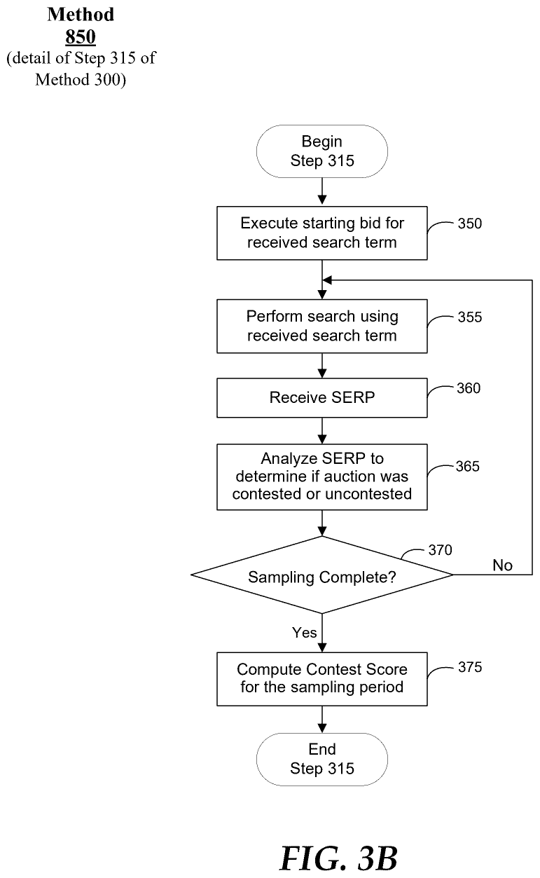

It will be understood that each block of the flow diagrams and block diagrams illustrated in FIGS. 3-5 and 7-8, and combinations of blocks in the flow diagram illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps that implement the actions specified in the flowchart block or blocks to be performed by the processor to produce a computer-implemented process or method. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems that perform the specified actions or steps, or combinations of special purpose hardware and computer instructions.

### General Method

FIG. 3A provides an overall method 300 that identifies contested and uncontested auctions for a search term and adjusts and executes bids accordingly. The method is typically performed a number of times over a time period, referred to as a sample period, in order to obtain statistically accurate results.

At step 305 rules for analyzing SERPS and bidding in auctions are stored and maintained. The subject invention specifically concerns uncontested auctions, so the only requirement is that rules concerning uncontested auctions be maintained. Auction rules may be defined explicitly as a dataset or, for example, as XML code. Alternatively, auction rules may be implicit in the code, which is executed by auction analyzer 135, where the code implements logic that implements at least one rule for analyzing SERPS to determine if an auction for a search term is contested or uncontested and then bidding on the search term using a corresponding bidding algorithm.

At step 310, ad server 130 receives a search term to process. This step may be performed in various ways. In certain embodiments, advertiser 160 simply provides a set of search terms to ad server 130 using advertiser computer 165 and advertiser app 168. These may be search terms that are currently being purchased by advertiser 160, or prospective search terms that advertiser 160 wishes to evaluate. In the case of multiple search terms, method 300 is typically performed sequentially for each received search term.

In certain embodiments, ad server 130 actively gathers search terms. For example, if a search engine marketing (SEM) program of a particular advertiser, e.g. Surebuy (see FIG. 2), is being evaluated, advertiser 160 can provide a list of search terms they typically purchase along with the corresponding paid ads and bid prices for the search terms.

Additional data can be obtained from search engines. For example, GOOGLE ADWORDS, provided by GOOGLE, INC. provides information including ad position, suggested bid price, click through rate, ad impression share and similar metrics.

At step 315 a method 350 executes that that computes a Contest Score for an auction for the received search term. The Contest Score estimates the likelihood that the auction is uncontested over a time interval, referred to as a sampling period.

At step 320 a determination is made, based on the Contest Score, as to whether the auction should be considered as contest or uncontested. This determination typically applies a threshold value to the Contest Score computed at step 340, e.g. if the Contest Score is greater than 98% then the auction for the designated search term is considered to be uncontested. If the auction is determined to have been uncontested the processing flows to step 325; otherwise, if the auction is determined to be contested processing flows to step 330.

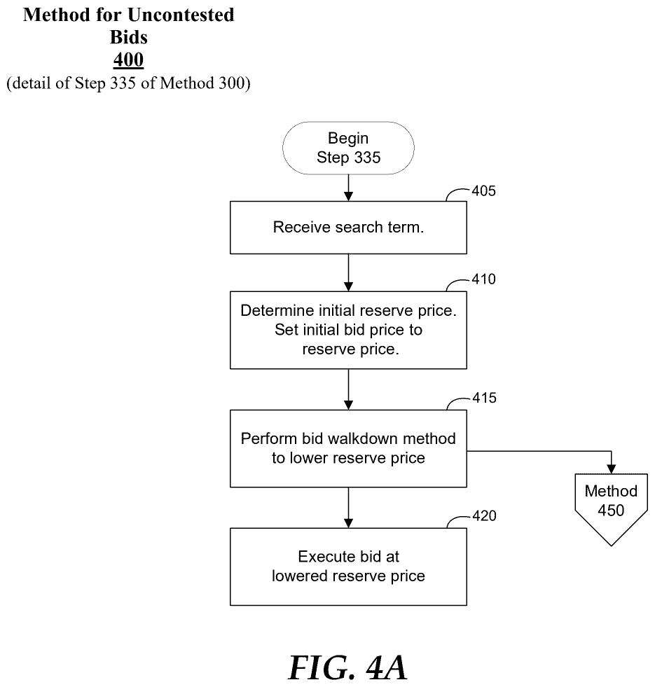

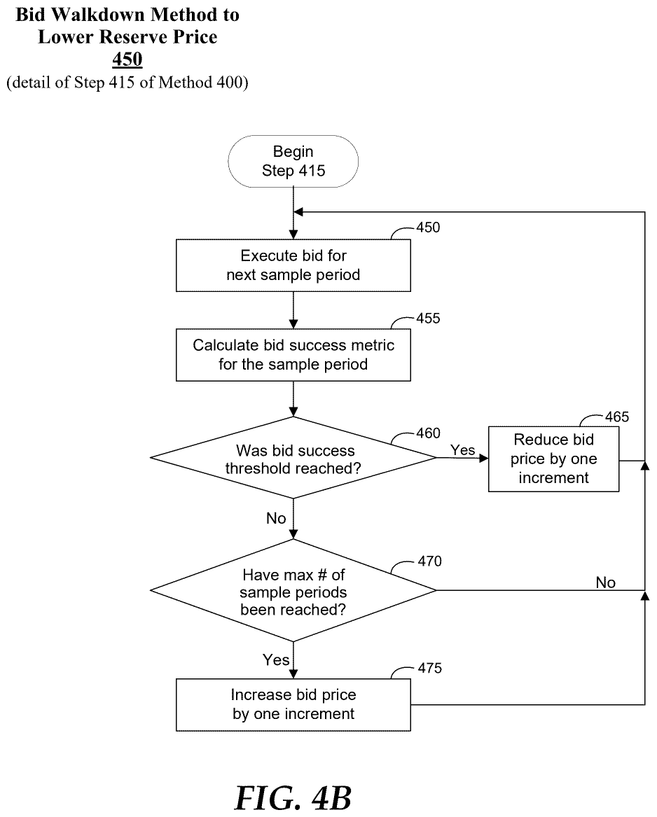

At step 325 a method 400 is performed that adjusts a bid price and executes the bid for the designated search term in the case that the auction for the search term was uncontested for the previous sampling period. The assumption is that if the auction was uncontested for the previous sampling period it will remain uncontested for the next sampling period at least. Method 400 is described in detail with reference to FIG. 4.

At step 330 a method is performed that executes a bid for the designated search term in the case that the auction for the search term was determined to be contested. This method is considered to be outside the scope of the current invention for the reason that it has been treated by a variety of prior art publications. For example, the GOOGLE ADWORDS help web page, available at https://support.google.com/google-ads/answer/2472725?sjid=17977103974460683482-NC provides suggestions about how to set bids based on the advertiser's goals. It includes strategies for manual CPC bidding, enhanced CPC bidding, cost-per-view bidding, and others. It may be appreciated that the GOOGLE information does not address the case of uncontested auctions.

In certain embodiments, a report is generated that includes the contest scores generated for each search term-paid ad combination. The report may also include the listing positions determined for the search terms. Such a report may encompass all gathered search terms or only those determined have uncontested auctions. For example, only search term-paid ad combinations that have a score higher than a given threshold value may be included in the report. The report is typically made available to advertiser 160 through advertiser app 168.

### Compute Contest Score

FIG. 3B provides an embodiment of a method 350 that computes a Contest Score for an auction for a search term that estimates the likelihood that that auction was uncontested over a sample period. Method 350 provides the detail of step 315 of method 300. Method 350 is performed iteratively over a sample period to ensure statistical accuracy. A sample period may be as short as one or several minutes or may last one or more hours or days. Note that while method 350 is performed for a single search engine 120, it can be performed additional times for other search engines of interest. Thus, method 350 applies equally to all search engines.

At step 350 a starting bid is executed for the received search term. The bid typically includes the search term along with a corresponding paid ad and a starting bid price, is provided to search engine 120. Method 300 assumes that the starting bid remains in place until it is replaced with another bid by ad server 130 or is canceled and not replaced. As discussed above, a starting bid price may be obtained in several ways. For example, it may be suggested by search engine 120 or it may be provided by advertiser 160.

At step 355 a keyword search is performed against search engine 120 for the received search term.

At step 360 a SERP is received from search engine 120 in response to the keyword search request.

At step 365 SERP is analyzed to determine if the auction was contested or uncontested. As previously discussed, the auction rules maintained by ad server 130 are used for this analysis. Interim results, referred to hereinbelow as samples, generated at this step are maintained until the current sample period ends, at which time they are processed. In the simplest case, an auction is determined to be uncontested if the paid ad corresponding to the search term being bid on appears in a SERP and is the only paid ad that appears.

At step 370 a determination is made as to whether sampling is complete, i.e. whether the sampling period has expired, or whether the designated number of samples have been collected and analyzed. If sampling is complete, then processing flows to step 375; otherwise processing returns to step 355 and another search is performed.

At step 375, a Contest Score for the search term is computed based on the samples collected during the sampling period. This step takes into account any rules stored at step 305. In the simplest case, a statistical average across the samples is computed that gives the percentage of auctions during the sample period that were uncontested.

### Uncontested Bid Method

FIGS. 4A and 4B provide a flow diagram that shows an overall method for adjusting and then executing bids for a search term in cases where a corresponding auction for the search term is determined to be uncontested. Method 400 provides the detail for step 355 of FIG. 3. Method 400 is performed by UA bidder 137.

FIG. 4A provides a flow diagram of an overall method for adjusting bids for a search term in cases where an auction for the search term is uncontested. The method begins at step 405 where a search term is received for processing.

At step 410 the initial reserve price for an auction for the search term is determined. Then, a bid price value is set to the determined initial reserve price. The initial reserve price is determined, in this step, by making an initial bid for the search term and then performing a search for the corresponding search term and examining the resulting SERP to determine if the ad appears in the SERP. This is repeated, each time using a lower bid price, until the corresponding ad no longer displays, i.e. no longer appears in a corresponding SERP. The previous, i.e. next-to-last, bid in the sequence is thus determined to be the initial reserve price. This assumes that the initial bid is successful and the ad displays; if not, i.e. if the paid ad doesn't appear in the SERP, then the starting bid value is below the initial reserve price and then bids must be made at sequentially higher prices until the ad displays. In this case, the last bid, which caused the ad to appear in the SERP, is determined to be the initial reserve price.

At step 415 a bid walkdown method 450 is performed to retrain the bidding algorithm performed by search engine 120 to lower the reserve price for the search term. Lowering the reserve price has the effect of reducing the cost of uncontested auctions. The detail for this step is provided in method 450, shown in FIG. 4B. Other methods, as well as variations of method 450 may also be used at this step to lower the reserve price without departing from the scope and spirit of the subject invention.

Finally, at step 420 a bid for the search term is executed using the most recently determined lowered reserve price. Alternatively, in certain embodiments, the lowered reserve price for a search term is provided to advertiser 160 or to another ad system that presumably places the bid with search engine 120.

FIG. 4B provides a flow diagram of a method 450 that retrains a search engine's bidding algorithm to lower the reserve price for a search term. Method 450 performs step 415.

At step 450 a bid is executed for the received search term at the initial bid price for a sample period, set in step 410. Henceforth, the bid price is gradually adjusted by method 450 over the course of a number of sample periods.

At step 455, after the bid is executed for a sample period a bid success metric, that estimates the success of the bid during the sample period, is calculated. One bid success metric is search impression share, i.e. the number of times the corresponding paid ad appears in a SERP during the sample period in relation to the total number of times it could have appeared. Other success metrics include, for example, the total number clicks by users, the cost per click (CPC), and the revenue generated due to the corresponding paid ad. Since the auction was determined to be uncontested, this means that the corresponding paid ad is usually the only paid ad that appears in the SERPs during the sample period.

At step 460 a determination is made as to whether the bid success metric reached a minimum threshold value, for example 95%. If so, the processing flows to step 465; if not, then processing flows to step 470.

At step 465 the bid price is reduced by one increment, i.e. by one unit of price such as $0.01, or one penny. This is to attempt to induce search engine 120 to accept a lower bid price for future sample periods. For example, if the previous bid was $0.50 then for future bids it might be reduced by a penny to $0.49—the logic being that if $0.49 is the only bid being offered, the bidding algorithm performed by search engine 120 it will prefer to lower the reserve price and accept the bid than maintain the $0.01 higher reserve price receive no ad money from an advertiser that is willing to pay the lower price.

If the bid threshold was not reached, as determined at step 460, then the bid is maintained for a number of sample periods. This allows the search engine bidding algorithm time to accept the lower reserve price.

At step 470, if the maximum number of sample periods has been reached then processing flows to step 475. If the maximum number of periods has not been reached, then the current bid price is not changed and processing returns to step 450.

At step 475 the bid price is increased by one increment or price step and processing returns to step 450. This restores the current bid price to a value that should cause the paid ad to appear in a SERP and consequently reflects a true minimum reserve price.

Method 450 is shown as being performed in a continuous loop. In some cases, the method terminates once the reserve price reaches a minimum value over a number of sample periods at step 475 and stops reducing any further. At step 420 of method 400 ad server 130 executes a bid using the most recently calculated bid price which, due to method 450 is a lowered reserve price in relation to the reserve price determined at step 410.

Method 450 is referred to as a bid walkdown method because over the course of many iterations it coaxes search engine 120 to accept a lower reserve price by gradually decreasing, or walking down, the bid. This reduces the search advertising cost for a search term for uncontested auctions.

### Flip-Flop Method

A flip-flop method may be used to control the switching between uncontested and contested bidding methods based on whether the most recent auction is determined to be contested or uncontested. The flip-flop method controls which of the two auction techniques, uncontested and contested, is used at a particular time. In one embodiment, the flip-flop method takes the list of search terms associated with an ad campaign and marks each one as active or positive or inactive or negative based on a determination as to whether the most recent auction for the search term is contested or uncontested. If the auction was uncontested then the keyword is marked as active; if the auction was determined to be contested, then the keyword is marked as inactive or negative. This ensures that at any point only one bidding strategy, contested or uncontested, is active for each search term.

### Software Modules

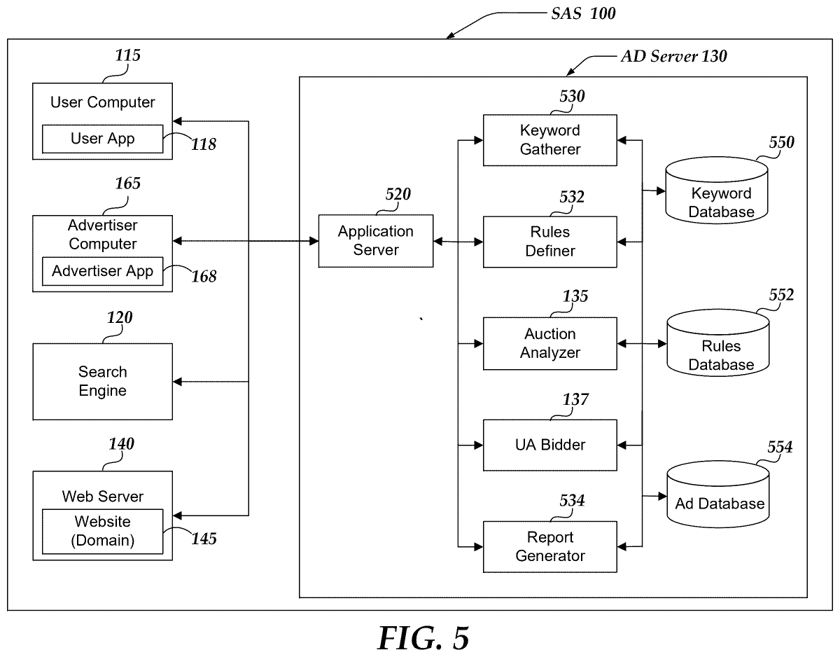

FIG. 5 is a block diagram that depicts one embodiment of the software modules of SAS 100 including user computer 115, advertiser computer 165 search engine 120, web server 140 and ad server 130.

User app 118 issues HTTP requests to and receives HTTP responses from Internet-connected computers such as search engine 120, and web server 140. Application server 520 receives the HTTP requests and invokes the appropriate ad server 130 software module to process the request. Application server 520 may be a commercially available application server that includes a web server that accepts and processes HTTP requests transmits HTTP responses back along with optional data contents, which may be web pages such as HTML documents and linked objects (images, or the like).

Advertiser app 168 may be a standard, commercially available, web browser such as MOZILLA FIREFOX or MICROSOFT INTERNET EXPLORER. Alternatively, it may also be a customer user application running in advertiser computer 165. Advertiser computer 165 is typically a PC, mobile device or other computer system configured to receive and display graphics, text, multimedia, and the like, across a network.

Application server 520 establishes and manages sessions with search engine 120 and web server 140. In addition, it may interact with user computer 115.

The software modules of search engine 120 are generally outside the scope of the present invention and are not discussed further herein. Web server 140 manages one or more websites 145 where each website includes one or more domains.

Ad server 130 includes a keyword gatherer 530, a rules definer 532, auction analyzer 135, a report generator 534, UA bidder 137, a keyword database 550, a rules database 552, and an ad database 554. It may be appreciated that each of the abovementioned databases may be implemented as one or more computer files spread across one or more physical storage mechanisms. In one embodiment, each of the abovementioned databases is implemented as one or more relational databases and is accessed using the structured query language (SQL).

Keyword gatherer 530 obtains search terms from search engine 120 and potentially from other sources. Keyword gatherer 530 may also obtain search terms from an advertiser, for example in computer files supplied by advertiser 160. Keyword gatherer 530 may also obtain initial bid prices for search terms from search engine 120 and advertiser 160. Keyword gatherer 530 stores search terms and other collected data in keyword database 550. Generally, it performs the processing performed at step 310 of method 300.

Rules definer 632 defines rules that determine a contest score for a paid ad in a SERP. It stores rules in rules database 552. Rules definer 532 implements step 305 of method 300. Rules definer 532 may be implemented in a variety of ways; for example, in certain embodiments rules definer 532 simply receives a text file that defines the rules; while in other embodiments it provides a graphic interface to client computer 115 that allows a user to interactively define rules. In yet other embodiments, rules may be part of the code that implements UA bidder 137, i.e. bid manager 137 may incorporate the logic as to how to determine a contest score for a paid ad. Generally, the method for defining rules is outside the scope of the present invention.

Auction analyzer 135 performs the processing associated with steps 315-345 of method 300. It uses gathered search terms stored in keyword database 550 to obtain SERPS, to analyze the SERPS, and generate intermediate information as necessary and to compute a contest score for a search term. It stores the results in ad database 554.

UA bidder 137 performs the processing associated with step 355 and method 400. UA bidder 137 adjusts and places bids with search engine 120 based on the data computed by auction analyzer 135.

Optionally, report generator 534 generates a report that provides the contest scores for ads from an advertiser. It stores the report in ad database 654.

Keyword database 550 stores gathered search terms and any related data such as bid prices.

In certain embodiments, rules database 552 stores rules that are used to generate a contest score.

Ad database 554 stores ads supplied by advertiser 160 that correspond to search terms. Generally, each search term of interest to an advertiser has a corresponding paid ad that may be placed with a search engine. Ad database 554 also stores results generated by auction analyzer 135, including contest scores. Ad database 554 also stores reports generated by report generator 534.

### Artificial Intelligence (AI) Embodiments

The forgoing embodiments assumed that user 110 uses a user app 118 to perform web searches against a search engine 120. However, users are increasingly posing questions to AI or LLM Chatbots, referred to herein simply as chatbots, rather than to search engines.

For example, FIGS. 6A and 6B provide examples of two such chatbot interactions. FIG. 6A illustrates a question 602 posed by a user to the CHATGPT chatbot from OPEN AI regarding local supermarkets. In response, the chatbot provides a list of local supermarkets 604 along with descriptive information.

FIG. 6B illustrates a question 622 posed by a user to the GEMINI chatbot from GOOGLE regarding the best supermarket in the State of California. In response, the chatbot provides an AI overview 624, which is a high level summary of the results, a set of listings 626, presumably unpaid, and a number of highlighted listings 628 in boxes with colored backgrounds along the right side of the screen.

With the emergence of LLM or AI Chatbots, referred to herein as chatbots, the definition of user app 718 is expanded to include apps such as GEMINI from GOOGLE and CHATGPT from OPEN AI that enable a user to interact with an AI or LLM engine that responds to user requests. User app 118 may also be a standard, commercially available, web browser such as GOOGLE CHROME, MOZILLA FIREFOX or MICROSOFT EDGE.

In this embodiment, user app 718 transmits a user 110 request to a chatbot engine 770 that that relies on a chatbot engine 770 to formulate and return a chatbot response which is then displayed by user app 718. The format of the chatbot response may be in any format. For example, it may include an AI summary, it may include explicitly marked unpaid listings, it may include explicitly marked paid listings, and it may include paid listings that are not explicitly indicated such as bulleted lists or text descriptions that embed paid ads. The paid ads may or may not include links to landing pages.

The response to a user 110 request from a chatbot engine 770 (referred to herein as a chatbot response) may be in HTML, as is returned by search engines to Web browsers, or it may be in another format such as XML or .DOCX. So, the general problem is how to identify a paid ad within a response from chatbot engine 770. The hypothesis made herein is that it will always be possible to parse a chatbot response to any paid ads included in the response. For example, ordinary paid ads returned by search engines are identified by analyzing HTML <div> tags which are used to identify paid ads.

An example of a div that includes a code snipped that displays a GOOGLE AD is given below in Listing 1. The script tag loading adsbygoogle.js is the main AdSense library. The ins element with class=“adsbygoogle” and data-ad-client and data-ad-slot attributes represents the specific ad unit. These data-ad-client and data-ad-slot values are unique identifiers provided by GOOGLE ADSENSE for an account and ad unit. The final script block (adsbygoogle=window.adsbygoogle∥[ ]).push({ }); initiates the ad loading.

While this, or a similar, tagging mechanism may be used within chatbot responses to request a GOOGLE AD. Alternatively, different chatbots may introduce their own tagging mechanism or a new standard approach may be adopted. However, the assumption made for purposes of this invention is that it will be a straightforward exercise to parse and identify such tags or ads within chatbot responses.

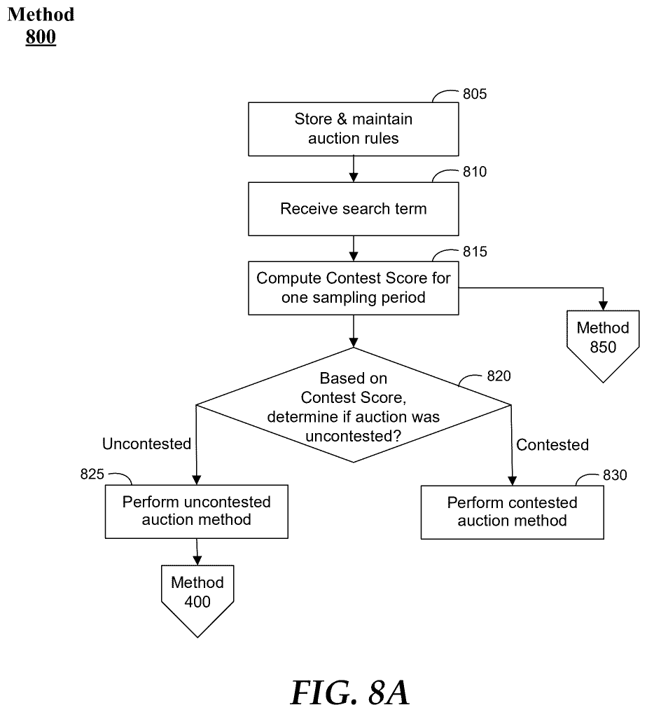

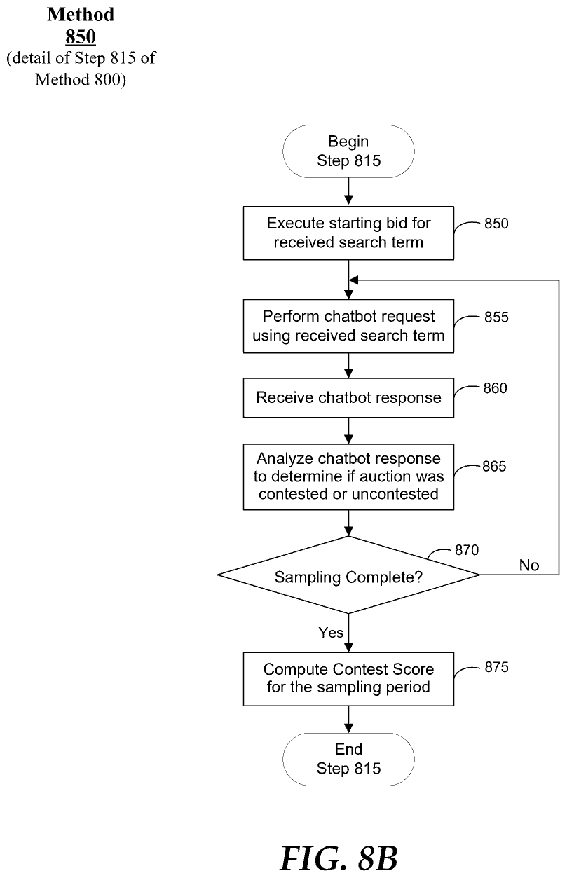

With this understanding, methods 300 and 350 are revised, as described hereinbelow in FIGS. 8A and 8B, to explicitly take into account the embodiment of chatbot advertising system 700 in which chatbot engine 770 delivers paid ads within chatbot responses.

### General Method

FIG. 8A provides a second embodiment of an overall method 800 that identifies contested and uncontested auctions for a search term and adjusts and executes bids accordingly. The method specifically applies to the case where the ads corresponding to search terms are inserted into chatbot responses. The method is typically performed a number of times over a time period, referred to as a sample period, in order to obtain statistically accurate results.

At step 805 rules for analyzing chatbot responses and bidding in auctions are stored and maintained. The subject invention specifically concerns uncontested auctions, so the only requirement is that rules concerning uncontested auctions be maintained. Auction rules may be defined explicitly as a dataset or, for example, as XML code. Alternatively, auction rules may be implicit in the code which is executed by auction analyzer 135, where the code implements logic that implements at least one rule for analyzing chatbot responses to determine if an auction for a search term is contested or uncontested and then bidding on the search term using a corresponding bidding algorithm.

At step 810, ad server 130 receives a search term to process. This step may be performed in various ways. In certain embodiments, advertiser 160 simply provides a set of search terms to ad server 130 using advertiser computer 165 and advertiser app 168. These may be search terms that are currently being purchased by advertiser 160, or prospective search terms that advertiser 160 wishes to evaluate. In the case of multiple search terms, method 800 is typically performed sequentially for each received search term.

In certain embodiments, ad server 130 actively gathers search terms. For example, if a search engine marketing (SEM) program of a particular advertiser is being evaluated, advertiser 160 can provide a list of search terms they typically purchase along with the corresponding paid ads and bid prices for the search terms.

Additional data can be obtained from search engines. For example, GOOGLE ADWORDS, provided by GOOGLE, INC. provides information including ad position, suggested bid price, click through rate, ad impression share and similar metrics.

At step 815 a method 850 executes that that computes a Contest Score for an auction for the received search term. The Contest Score estimates the likelihood that the auction is uncontested over a time interval, referred to as a sampling period.

At step 820 a determination is made, based on the Contest Score, as to whether the auction should be considered as contest or uncontested. This determination typically applies a threshold value to the Contest Score computed at step 340, e.g. if the Contest Score is greater than 98% then the auction for the designated search term is considered to be uncontested. If the auction is determined to have been uncontested the processing flows to step 825; otherwise, if the auctions is determined to be contested processing flows to step 830.

At step 825 a method 400 is performed that adjusts a bid price and executes the bid for the designated search term in the case that the auction for the search term was uncontested for the previous sampling period. The assumption is that if the auction was uncontested for the previous sampling period it will remain uncontested for the next sampling period at least. Method 400 is described in detail with reference to FIG. 4.

At step 830 a method is performed that executes a bid for the designated search term in the case that the auction for the search term was determined to be contested. This method is considered to be outside the scope of the current invention for the reason that it has been treated by a variety of prior art publications.

In certain embodiments, a report is generated that includes the contest scores generated for each search term-paid ad combination. The report may also include the listing positions determined for the search terms. Such a report may encompass all gathered search terms or only those determined have uncontested auctions. For example, only search term-paid ad combinations that have a score higher than a given threshold value may be included in the report. The report is typically made available to advertiser 160 through advertiser app 718.

### Compute Contest Score

FIG. 8B provides a second embodiment of a method 850 that computes a Contest Score for an auction for a search term that estimates the likelihood that that auction was uncontested over a sample period. Method 850 is intended for use when the ad corresponding to the search term is incorporated into a chatbot response. Method 850 provides the detail of step 815 of method 800. Method 850 is performed iteratively over a sample period to ensure statistical accuracy. A sample period may be as short as one or several minutes or may last one or more hours or days. Note that while method 850 is performed for a single chatbot engine 770, it can be performed additional times for other chatbot engines of interest. Thus, method 850 applies equally to all chatbot engines.

At step 850 a starting bid is executed for the received search term. The bid typically includes the search term along with a corresponding paid ad and a starting bid price, is provided to chatbot engine 770. It is assumed that the starting bid remains in place until it is replaced with another bid by ad server 130 or is canceled and not replaced. As discussed above, a starting bid price may be obtained in several ways. For example, it may be suggested by chatbot engine 770 or it may be provided by advertiser 160.

At step 855 a chatbot request is performed against chatbot engine 770 for the received search term. A chatbot request may simply be the keyword itself or it may be wrapped in a simple sentence.

At step 860 a chatbot response is received from chatbot engine 770 in response to the keyword search request.

At step 865 the chatbot response is analyzed to determine if the auction was contested or uncontested. As previously discussed, the auction rules maintained by ad server 130 are used for this analysis.

Generally, the rules for analyzing chatbot responses will vary based on the type of chatbot engine and how they incorporate ads into chatbot responses. Below is a Table 1 that identifies some of the ways that ads currently appear in chatbot responses. These and other ways of incorporating ads into chatbot responses are within the scope of the present invention.

TABLE 1
Ways in which paid ads appear in chatbot responses

| Name | Description |
|---|---|
| Sponsored links and | Some AI platforms provide sponsored |
| suggestions. | content. This can take the form of |
| | sponsored follow-up questions or links |
| | presented alongside the chatbot's |
| | answers. |
| Integrated | Some chatbots incorporate product |
| recommendations | ads directly into conversational |
| | responses. For example, a user asking |
| | for advice might receive a response |
| | that includes specific product |
| | recommendations and links to online |
| | stores. |
| In-app ad placement | Some chatbots are testing placing ads |
| | within conversations on third-party AI |
| | platforms. These ads are contextually |
| | relevant to the ongoing chat, similar |
| | to how ads appear in traditional |
| | search results. |
| Native ads in bot | Some chatbots will show ads directly |
| answers | within its generated answers. The ads |
| | are presented as suggestions for |
| | products or services that solve a |
| | user's problem |

Interim results, referred to hereinbelow as samples, generated at this step are maintained until the current sample period ends, at which time they are processed. In the simplest case, an auction is determined to be uncontested if the paid ad corresponding to the search term being bid on appears in a chatbot response and is the only paid ad that appears.

At step 870 a determination is made as to whether sampling is complete, i.e. whether the sampling period has expired, or whether the designated number of samples have been collected and analyzed. If sampling is complete, then processing flows to step 875; otherwise processing returns to step 855 and another search is performed.

At step 375, a Contest Score for the search term is computed based on the samples collected during the sampling period. This step takes into account any rules stored at step 805. In the simplest case, a statistical average across the samples is computed that gives the percentage of auctions during the sample period that were uncontested.

The above specification, examples, and data provide a complete description of the manufacture and use of the composition of the invention. Many embodiments of the invention can be made without departing from the spirit and scope of the invention.

Listing 1: Example of a div containing a code snipped for a
GOOGLE ad
<div id = “ad-container” class = “google-ad-slot”>
<script async src = “https://pagead2.googlesyndication.com/
pagead/js/adsbygoogle.js”></script>
<!-- Google AdSense ad unit -->
<ins class = “adsbygoogle”
style = “display: block”
data-ad-client = “ca-pub-XXXXXXXXXXXXXXX”
data-ad-slot = “YYYYYYYYY”></ins>
<script>
(adsbygoogle = window.adsbygoogle | | []).push({});
</script>
</div>

What is claimed is:

1. A computer-implemented method for adjusting internet advertising bids in internet advertising campaigns, comprising:
maintaining at least one auction rule that that specifies how to adjust a bid for a search term in an internet advertising auction in the case that the auction is determined to be uncontested, wherein a successful bid for a search term results in a corresponding paid ad provided by an advertiser to appear in a chatbot response that is returned by a chatbot engine in response to a chatbot request, and, wherein in an uncontested auction the SERP displays only one paid ad, the paid ad provided by the advertiser;
receiving a search term;
computing a contest score that estimates the likelihood that an auction for the search term is uncontested;
determining, based on the contest score that the auction is uncontested; and
performing an uncontested auction method that executes a bid for the search term, wherein the uncontested auction method (1) performs a bid walkdown method that lowers the reserve price for the search term, and (2) executes a bid for the search term at the lowered reserve price.

2. The method of claim 1 wherein computing a contest score comprises:
periodically, during a sample period:
executing a starting bid for the received search term;
performing a chatbot request using the received search term;
receiving a chatbot response;
analyzing the chatbot response to determine if the auction was contested or uncontested; and
upon completion of the sample period, computing a contest score that reflects the percentage of auctions that were uncontested during the sample period.

3. The method of claim 1 wherein performing a bid walkdown method comprises:
executing a bid for the sample period;
calculating a bid success metric for the sample period that indicates how successful the success of the bid;
determining, based on the bid success metric, if a success threshold was reached;
upon determining that the bid success metric was successful, reducing the bid price by one increment;
upon determining that the bid success metric wasn't successfully reached, determining if a maximum number of sample periods have been reached; and
upon determining that the maximum number of sample periods have been reached, increasing the bid price by one increment.

4. The method of claim 3 wherein the bid success metric is selected from the group consisting of search impression share, number of clicks, and cost per click.

5. A server computer implemented on a search advertising system (SAS), comprising:
a processor;
a communication interface in communication with the processor;
a data storage for storing (1) a plurality of keywords, (2) a plurality of ads, wherein each keyword corresponds to a paid ad that an advertiser intends to purchase as part of an internet advertising campaign, and (3) at least one auction rule that that specifies how to adjust a bid for a search term in an internet advertising auction in the case that the auction is determined to be uncontested, wherein a successful bid for a search term results in a corresponding paid ad provided by the advertiser to appear in a chatbot response that is returned by a chatbot engine in response to a chatbot request, and, wherein in an uncontested auction the chatbot response includes only one paid ad, the paid ad provided by the advertiser;
a memory in communication with the processor for storing instructions, which when executed by the processor, cause the server:
to receive a search term;
to compute a contest score that estimates the likelihood that an auction for the search term is uncontested;
to determine, based on the contest score that the auction is uncontested; and
to execute an uncontested auction method that results in a bid for the search term, wherein the uncontested auction method (1) performs a bid walkdown method that lowers the reserve price for the search term, and (2) executes a bid for the search term at the lowered reserve price.

6. The server computer of claim 5 wherein computing a contest score comprises:
periodically, during a sample period:
executing a starting bid for the received search term;
performing a chatbot request using the received search term;
receiving a chatbot response;
analyzing the chatbot response to determine if the auction was contested or uncontested; and
upon completion of the sample period, computing a contest score that reflects the percentage of auctions that were uncontested during the sample period.

7. The server computer of claim 1 wherein performing a bid walkdown method comprises:
executing a bid for the sample period;
calculating a bid success metric for the sample period that indicates how successful the success of the bid;
determining, based on the bid success metric, if a success threshold was reached;
upon determining that the bid success metric was successful, reducing the bid price by one increment;
upon determining that the bid success metric wasn't successfully reached, determining if a maximum number of sample periods have been reached; and
upon determining that the maximum number of sample periods have been reached, increasing the bid price by one increment.

8. The server computer of claim 7 wherein bid success metric is selected from the group consisting of search impression share, number of clicks, and cost per click.
